(19) United States
(12) Patent Application Publication
(10) Pub. No.: US 2026/0341085 A1
(43) Pub. Date: Oct. 29, 2026

(54) Secondary Cabinet Control Via a Joined Primary Cabinet

(71) Applicant: 365 Retail Markets, LLC, Troy, MI (US)

(72) Inventors: Boris Amegadjie, Chicago, IL (US); James Brinton, Redmond, WA (US); Joseph Hessling, Brimingham, MI (US); Ryan McWhirter, Saint Clair Shores, MI (US)

(21) Appl. No.: 19/193,319

(22) Filed: Apr. 29, 2025

(51) Int. Cl. G07C 9/00; G06Q 20/20

(52) U.S. Cl. CPC G07C 9/00182; G06Q 20/208; G07C 2009/00198

(57) ABSTRACT

A joined cabinet system includes a primary merchandiser device including a computing device, a first controller, and a first storage area and a secondary merchandiser device including a second controller and a second storage area. The primary merchandiser device and the secondary merchandiser device are daisy chained via the computing device. The computing device, based on input authenticating a user for a transaction, transmits a first signal to the first controller and a second signal to the second controller. The first controller, via the first signal, unlocks a lock mechanism of the first storage area to enable access to the first storage area. The second controller, via the second signal, unlocks the lock mechanism of the second storage area to enable access to the second storage area.

### TECHNICAL FIELD

This disclosure relates to joined cabinets, and, more specifically, to secondary cabinet control via a joined primary cabinet.

### BACKGROUND

Merchandiser devices, such as retail cabinets which may be enclosed or open, are commonly found in physical retail environments and used to store product inventory while awaiting purchase. A customer may retrieve one or more products stored within a merchandiser device as part of a transaction to purchase those one or more products. Similarly, a customer may replace one or more products within a merchandiser device where they decide against purchasing those one or more products. Inventories of products stored within a merchandiser device may be monitored to ensure product availability for customers.

### SUMMARY

Disclosed herein are, inter alia, implementations of systems and techniques for secondary cabinet control via a joined primary cabinet.

A joined cabinet system according to some implementations of this disclosure comprises a computer terminal, a primary merchandiser device, and a secondary merchandiser device. The computer terminal obtains input authenticating a user for a transaction. The primary merchandiser device includes a computing device in communication with the computer terminal, a first controller in communication with the computing device, and a first storage area. The secondary merchandiser device including a second controller in communication with the computing device and a second storage area. Based on the input, the computing device is configured to transmit, to the first controller, a first signal configured to cause the first controller to unlock a lock mechanism of the first storage area to enable access by the user to the first storage area, and transmit, to the second controller, a second signal configured to cause the second controller to unlock a lock mechanism of the second storage area to enable access by the user to the second storage area.

A joined cabinet system according to some implementations of this disclosure comprises a primary merchandiser device and a secondary merchandiser device. The primary merchandiser device includes a computing device, a first controller in communication with the computing device, and a first storage area. The secondary merchandiser device includes a second controller in communication with the computing device and a second storage area. Based on input authenticating a user for a transaction, the computing device is configured to transmit, to the first controller, a first signal configured to cause the first controller to unlock a lock mechanism of the first storage area to enable access by the user to the first storage area, and transmit, to the second controller, a second signal configured to cause the second controller to unlock a lock mechanism of the second storage area to enable access by the user to the second storage area.

A joined cabinet system according to some implementations of this disclosure comprises a primary merchandiser device and a secondary merchandiser device. The primary merchandiser device includes a computing device, a first controller, and a first storage area. The secondary merchandiser device includes a second controller and a second storage area. The first controller, via a first signal transmitted from the computing device based on input authenticating a user for a transaction, unlocks a lock mechanism of the first storage area to enable access to the first storage area. The second controller, via a second signal transmitted from the computing device based on the input, unlocks a lock mechanism of the second storage area to enable access to the second storage area. The primary merchandiser device and the secondary merchandiser device are daisy chained via the computing device.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a self-service market system.

FIG. 2 is a block diagram of an example of an internal configuration of a computing device of a self-service market system.

FIG. 3 is a block diagram of an example of a joined cabinet system.

FIG. 4 is an illustration of an example configuration of joined primary and secondary cabinets of a joined cabinet system.

FIG. 5 is a block diagram of example functionality of joined primary and secondary cabinets of a joined cabinet system.

FIG. 6 is a flowchart of an example of a technique for secondary cabinet control via a joined primary cabinet.

### DETAILED DESCRIPTION

Shopping in a conventional brick and mortar retail store, such as a grocery or convenience store, involves consumers retrieving products from various units (e.g., shelves, cabinets, or refrigerators), placing those retrieved products into a cart or basket, and ultimately initiating and completing a transaction to purchase those retrieved products at either a human-operated or self-service checkout area. In some cases, inventory records associated with the purchased products can be updated based on the completion of such a transaction. Units at the store are manually monitored from time to time by workers to restock product inventory on an as-needed basis and to ensure that products are not misplaced in the wrong units.

While brick and mortar retail shopping experiences have certain benefits, they also suffer from several substantial drawbacks, including that they are often inconvenient for consumers who must wait in long checkout lines after retrieving their desired items to complete a purchase transaction and that their operation generally requires a non-trivial number of human workers. One solution to these drawbacks is by way of a self-service market, which allows consumers to conveniently purchase products directly from their personal devices or from market devices without waiting in checkout lines and which can be operated without requiring human workers to continuously be present. Information associated with purchase transactions may be communicated to a device of a human operator who, on an as-needed basis, can restock the various units within the self-service market.

In a typical self-service market system, a consumer uses either a personal device, such as a mobile phone, or a market device, such as a kiosk device (e.g., a standalone countertop or floor-standing device not physically integrated on or otherwise within a merchandiser device) or an integrated device (e.g., a device integrated on or otherwise within a merchandiser device, such as a vending interface device), to initiate and complete a transaction for one or more products stored within a merchandiser device. In particular, each merchandiser device stores some number of products of some number of product types and the various products or product types may be shared or different between the various merchandiser devices of the self-service market system. Each merchandiser device includes its own integrated controller configured to facilitate communications between the merchandiser device and the device used by the consumer (i.e., a personal device or a market device), whether indirectly (i.e., via one or more intermediary devices, such as a server device involved in the subject transaction) or directly (i.e., without the use of such one or more intermediary devices).

However, there are situations where such a typical system is not advantageous. For example, a consumer who wants to purchase products from multiple merchandiser devices that each have their own integrated device used to facilitate transactions only at that merchandiser device must rely upon the separate integrated devices and thus use them to initiate and complete multiple separate transactions, each via a different integrated device. This repetitive process requires extra time from the consumer and in some cases may be flagged as suspicious activity by a credit institution used by the consumer. Moreover, because conventional merchandiser device systems are configured to maintain transactional and product security, such systems typically are specifically designed to limit access to a second merchandiser device by a first merchandiser device, instead relying upon separate transactions to ensure unrelated merchandiser devices are not unlocked and accessed.

Implementations of this disclosure address problems such as these using a joined cabinet system by which one or more secondary cabinets are controlled via a joined primary cabinet. A joined cabinet system as disclosed herein a primary cabinet, also referred to as a primary merchandiser device, and at least one secondary cabinet, each also referred to as a secondary merchandiser device. The primary merchandiser device includes a computing device, a first controller, and a first storage area. The secondary merchandiser device includes a second controller and a second storage area. The primary merchandiser device and the secondary merchandiser device are daisy chained via the computing device. In particular, the computing device is in communication with a computer terminal from which input authenticating a user for a transaction is obtained, the first controller is in communication with the computing device, and the second controller is in communication with the computing device. The computing device, based on the input authenticating the user for the transaction, transmits a first signal to the first controller and a second signal to the second controller. The first controller, via the first signal, unlocks a lock mechanism of the first storage area to enable access to the first storage area. The second controller, via the second signal, unlocks the lock mechanism of the second storage area to enable access to the second storage area.

The daisy chaining between the computing device, the first controller, and the second controller enables the use of a single computer terminal (e.g., a market device, such as a vending interface device, or a personal device, such as a mobile phone) to initiate a transaction and cause lock mechanisms of both of the first storage area of the primary merchandiser device and the second storage area of the secondary merchandiser device to unlock to enable access thereto. Thus, a user, via the single computer terminal, may access multiple storage areas of a joined cabinet system according to the implementations of this disclosure. The user may accordingly, via the single computer terminal, retrieve one or more products stored within the first storage area of the primary merchandiser device and one or more products stored within the second storage area of the secondary merchandiser device as part of the transaction. Cameras positioned within the first storage area and within the second storage area can capture images or video usable to identify the one or more products retrieved from each such storage area, thereby enabling the joined cabinet system to intelligently determine the products that are associated with the transaction and charge an amount based on the retrieved products to an account associated with the user. Similarly, the daisy chaining further enables the lock mechanisms of both merchandiser devices to, via signals transmitted from the computing device of the primary merchandiser device, lock following a determined completion of the transaction.

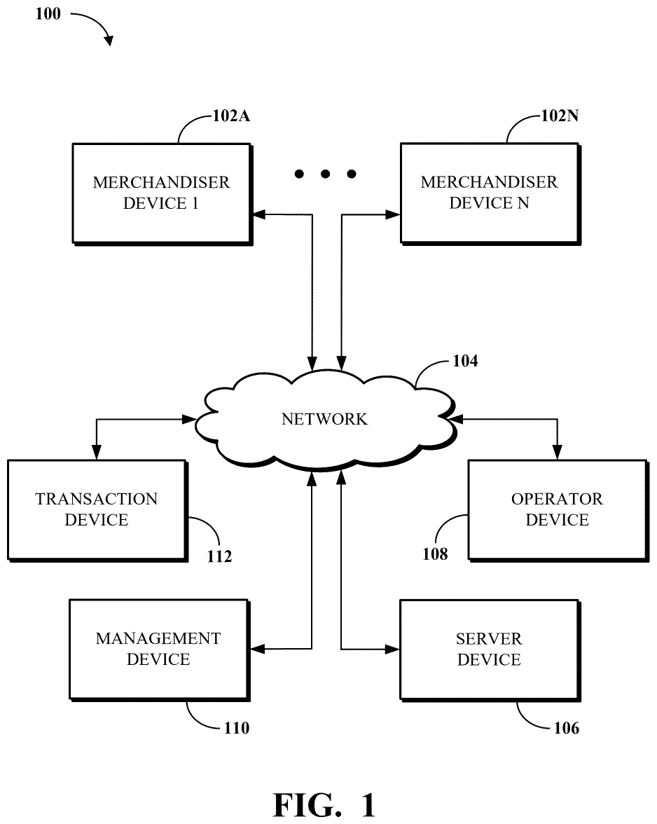

To describe some implementations in greater detail, reference is first made to examples of hardware structures which may be used. FIG. 1 is a block diagram of an example of a self-service market system 100. The self-service market system 100 includes multiple merchandiser devices 102A through N that each stores one or more products of one or more product types available for retail sale. While only two merchandiser devices 102A and 102N are shown, the self-service market system 100 may be understood to include two or more such merchandiser devices.

Each merchandiser device 102A through 102N includes a storage area with one or more shelves, horizontal dividers, lanes, and/or the like capable of storing its one or more products. Each of the merchandiser devices 102A through 102N may be a refrigerated unit or a non-refrigerated unit. For example, a merchandiser device 102A which is a refrigerated unit may include a compressor and other hardware configured to control an interior temperature of the merchandiser device 102A while a merchandiser device 102N which is an ambient (i.e., non-refrigerated) unit may not include a compressor or such other temperature control hardware. Each of the merchandiser devices 102A through 102N may in at least some cases include a door.

At least some of the merchandiser devices 102A through 102N include a computing device configured to facilitate processing in connection with a transaction for one or more products stored thereat. The computing device of a given merchandiser device 102A through 102N at least includes a memory, a processor, and a network interface. The memory is configured to store instructions executable by the processor to interface with hardware of the merchandiser device or of another merchandiser device. The processor is configured to execute the instructions stored in the memory. The network interface is configured to communicate, via a network 104, with one or more other devices, for example, one or more of another merchandiser device 102A through 102N, a server device 106, an operator device 108, a management device 110, or a transaction device 112.

In one non-limiting example, and as will be described below, a primary cabinet (e.g., the merchandiser device 1 102A) may include a computing device that communicates with components (e.g., a controller or computing device) of a secondary cabinet (e.g., the merchandiser device N 102N) to cause the secondary cabinet to perform some function (e.g., unlocking a door thereof to enable user (i.e., consumer) access to a product stored in a storage area thereof). In some cases, the computing device of a given merchandiser device 102A through 102N may be an integrated circuit, (e.g., an application-specific integrated circuit (ASIC)), a field-programmable gate array (FPGA), a system-on-a-chip (SoC), or another special purpose device. For example, such a computing device, as an ASIC, FPGA, or SoC, independently or otherwise in connection with another such computing device, may be configured to perform some or all the functionality of a joined cabinet system disclosed herein.

The server device 106 is a computing device that provides information usable to perform some or all of the functionality for facilitating transactions for products stored within one or more of the merchandiser devices 102A through 102N. For example, the server device 106 may provide to the computing device of a primary merchandiser device (e.g., the merchandiser device 102A) information associated with products stored within the storage area thereof, such as planogram data identifying locations of respective products within the storage area. In another example, the server device 106 may provide update data usable to cause the computing device of the primary merchandiser device to update some or all of the software executed, interpreted, called, or otherwise run thereat. The server device 106 may be located on premises at the store or other location of the merchandiser devices 102A through 102N. Alternatively, the server device 106 may be remote from such location, for example, in a datacenter.

The operator device 108 is a computing device used by a person who operates the merchandiser device 102. For example, the operator device 108 may be a mobile device of a person who works at a store or other location at which the merchandiser device 102 is located, such as a person tasked with monitoring product inventories and maintaining stock of products in the merchandiser device 102. The operator device 108 may receive alerts in connection with one or more events detected by the computing device 108. For example, the operator device 108 may receive an alert when a stock of a given product within a merchandiser device 102 falls below a threshold. In another example, the operator device 108 may receive an alert when wrong lane events related to the replacement of a product in an incorrect lane are detected by the computing device 108. In yet another example, the operator device 108 may receive an alert when suspicious activity is detected in connection with the merchandiser device 102.

The management device 110 is a computing device used by a person who manages the merchandiser devices 102A through 102N or otherwise who manages a store or other location at which the merchandiser device devices 102A through 102N are operated. For example, the management device 110 may be a desktop or laptop computer within an office at a retail store that includes the merchandiser devices 102A through 102N. The management device 110 may be used to create, assert, and/or update a planogram for the products of each of the merchandiser devices 102A through 102N. The management device 110 may receive inventory alerts related to trends in product transactions and be used to implement product stock changes based on analyses over those trends. The management device 110 may receive information related to individual transactions at the merchandiser devices 102A through 102N, products associated with those transactions, and the like.

The transaction device 112 is a computing device used by a user who initiates a transaction for one or more products stored at one or more of the merchandiser devices 102A through 102N. The transaction device 112 is a computer terminal at which a transaction for such products may be initiated and which may accordingly receive, from the user, input associated with the transaction. The transaction device 112 is one of a personal device, such as a mobile phone, or a market device, such as a kiosk device (e.g., a standalone countertop or floor-standing device not physically integrated on or otherwise within a merchandiser device) or an integrated device (e.g., a device integrated on or otherwise within a merchandiser device, such as a vending interface device). For example, the transaction device 112 may be a smartphone running a mobile application or a web application (e.g., via a web browser) at which information associated with a user account registered for purchasing products from ones of the merchandiser devices 102A through 102N can be viewed. In another example, the transaction device 112 may be a vending interface device integrated on or otherwise within one of the merchandiser devices 102A through 102N. The transaction device 112 may in some cases receive alerts related to products retrieved by the user from ones of the merchandiser devices 102A through 102N, products replaced by the user within the merchandiser devices 102A through 102N, and transactions processed in connection with products retrieved by the user from the merchandiser devices 102A through 102N. The transaction device 112 may display information associated with an account of the user before and/or after such a transaction is processed.

The network 104 is, includes, or otherwise refers to a computer network or portion thereof usable to facilitate communications between the various devices of the self-service market system 100. For example, the network 104 can be or include the Internet, a local area network (LAN), a wide area network (WAN), a virtual private network (VPN), or another public or private means of electronic computer communication capable of transferring data between network-connected devices. In some cases, the network 104 may be or include multiple different networks implemented via the same or different means. For example, the network 104 can include or otherwise refer to a first connection means between the transaction device 112 and the merchandiser device 1 102A as well as a second connection means between the merchandiser device 1 102A and the merchandiser device N 102N.

In some implementations, one or more of the server device 106, the operator device 108, the management device 110, and the transaction device 112 may be combined into a single device. For example, a single device may be used as both the operator device 108 and the management device 110. In some implementations, one or more of the server device 106, the operator device 108, or the management device 110 may be omitted.

In some implementations, the self-service market system 100 may include multiple of one or more of the server device 106, the operator device 108, the management device 110, or the transaction device 112. For example, the self-service market system 100 may include a first transaction device as a personal device, such as a mobile phone, and a second transaction device as a market device, such as a vending interface device. In some such cases, the first transaction device may communicate with the second transaction device to transmit input associated with a transaction from the first transaction device to the second transaction device, and the second transaction device may thereafter use the obtained input to facilitate the transaction via one or more of the merchandiser devices 102A through 102N.

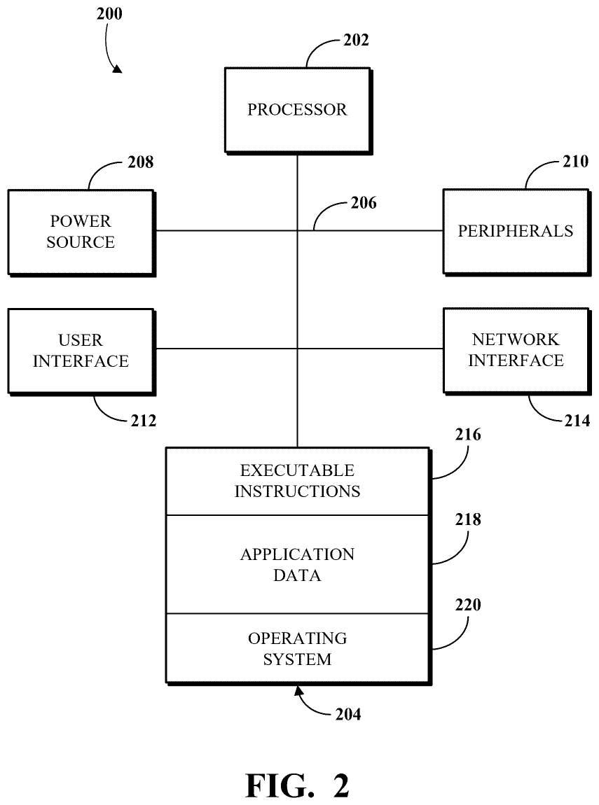

FIG. 2 is a block diagram of an example of an internal configuration of a computing device 200 of a self-service market system, for example, the self-service market system 100 shown in FIG. 1. The computing device 200 may, for example, be a computing device of a merchandiser device (e.g., one of the merchandiser devices 102A through 102N), the server device 106, the operator device 108, the management device 110, or the transaction device 112 shown in FIG. 1. The computing device 200 includes components or units, such as a processor 202, a memory 204, a bus 206, a power source 208, peripherals 210, a user interface 212, and a network interface 214. One of more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in any manner, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid state drive, flash memory, phase-change memory, or another form of non-volatile memory configured for persistent electronic information storage. The memory 204 may also include other types of devices, now existing or hereafter developed, configured for storing data or instructions for processing by the processor 202.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. The operating system 220 can be, for example, Microsoft Windows®, Mac OS X®, or Linux®; an operating system for a small device, such as a smartphone or tablet device; or an operating system for a large device, such as a mainframe computer.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network, for example, a local area network, a wide area network, a machine-to-machine network, a virtual private network, or another public or private network. The network interface 214 can be a wired network interface or a wireless network interface. The computing device 200 can communicate with other devices via the network interface 214 using one or more network protocols, such as using Ethernet, TCP, IP, power line communication, Wi-Fi, Bluetooth®, infrared, GPRS, GSM, CDMA, Z-Wave, ZigBee, another protocol, or a combination thereof.

Implementations of the computing device 200 may differ from what is shown and described above with respect to FIG. 2. In some implementations, the computing device 200 can omit the peripherals 210. In some implementations, the memory 204 can be distributed across multiple devices. For example, the memory 204 can include network-based memory or memory in multiple clients or servers performing the operations of those multiple devices. In some implementations, the application data 218 can include functional programs, such as a web browser, a web server, a database server, another program, or a combination thereof.

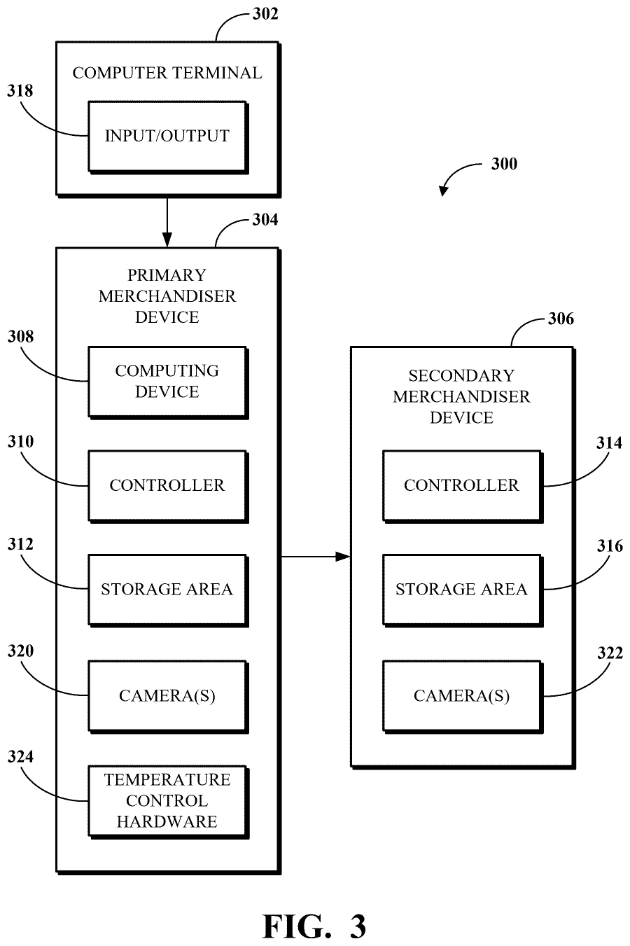

FIG. 3 is a block diagram of an example of a joined cabinet system 300, which may also be referred to as a system for secondary cabinet control via a joined primary cabinet. The joined cabinet system 300 includes a computer terminal 302 and multiple merchandiser devices (i.e., cabinets), including a primary merchandiser device 304 and a secondary merchandiser device 306. The computer terminal 302 is a transaction device configured to obtain, from a user, input associated with a transaction and provide (e.g., transmit, relay, or otherwise communicate) the input for processing with the primary merchandiser device 304 and the secondary merchandiser device 306. The computer terminal 302 may, for example, be the transaction device 112 shown in FIG. 1. The primary merchandiser device 304 and the secondary merchandiser device 306 may, for example, each be one of the merchandiser devices 102A through 102N shown in FIG. 1. The primary merchandiser device 304 and the secondary merchandiser device 306 are considered joined cabinets based on the physical connection of the primary merchandiser device 304 and the secondary merchandiser device 306, which physical connection may involve one or more of a variety of structural, mechanical, electrical, and/or other connections. While two merchandiser devices 304 and 306 are shown, the joined cabinet system 300 may in some cases include more than two such merchandiser devices. In such a case, one of the merchandiser devices is a primary merchandiser device and the others are each a different secondary merchandiser device.

The joined cabinet system 300, based on input obtained via the computer terminal and authenticating a user for a transaction, enables a processing of the transaction at both of the primary merchandiser device 304 and the secondary merchandiser device 306 by a daisy chaining of the primary merchandiser device 304 and the secondary merchandiser device 306 via a computing device 308 of the primary merchandiser device 304. In particular, the joined cabinet system 300 enables the computing device 308 to process input obtained using the computer terminal 302 to determine that the input authenticates the user of the computer terminal 302 for a transaction initiated via the computer terminal 302 in which the transaction is for products including at least a first product available at the primary merchandiser device 304 and a second product available at the second merchandiser device 306. Based on the input, the computing device 308 causes lock mechanisms of the primary merchandiser device 304 and the secondary merchandiser device 306 to unlock to enable access to the first product and the second product. Thus, the primary merchandiser device 304 and the secondary merchandiser device 306 are daisy chained for data processing via the primary merchandiser device 304 and the secondary merchandiser device 306.

The primary merchandiser device 304 includes a controller 310 and a storage area 312. Similarly, the secondary merchandiser device 306 includes a controller 314 and a storage area 316. To distinguish for the purpose of discussion, the controller 310 and the storage area 312 will respectively be referred to as a first controller 310 and a first storage area 312 and the controller 314 and the storage area 316 will respectively be referred to as a second controller 314 and a second storage area 316. The first controller 310 unlocks, via a first signal that is based on the input obtained from the computer terminal 302, a lock mechanism of the first storage area 312 to enable access to the first storage area 312. A second signal is transmitted to the second controller 314. The second controller 314, via the second signal, unlocks a lock mechanism of the second storage area 316 to enable access to the second storage area 316.

Each of the first controller 310 and the second controller 314 is a computing device configured to receive and transmit information from and to one or more other computing devices. For example, each of the first controller 310 and the second controller 314 may include a processor, a memory, and a network interface. Thus, each of the first controller 310 and the second controller 314 may be a computing device separate from but nonetheless may communicate with the computing device 308. However, in some implementations, the computing device 308 may be omitted and its operations performed instead by the first controller 310 and/or the computer terminal 302.

Each of the first storage area 312 and the second storage area 316 is an enclosed space representing the main internal section of the primary merchandiser device 304 and the secondary merchandiser device 306, respectively. Each of the first storage area 312 and the second storage area 316 is enclosed by walls, a top and bottom surface, and a door. The door of each of the primary merchandiser device 304 and the secondary merchandiser device 306 is secured by a locking mechanism. For example, the first storage area 312 may include a first locking mechanism that restricts access to the first storage area 312 via the door of the primary merchandiser device 304 when the first locking mechanism is locked, and the second storage area 316 may similarly include a second locking mechanism that restricts access to the second storage area 316 via the door of the secondary merchandiser device 306 when the second locking mechanism is locked.

The first storage area 312 and the second storage area 316 are each configured to house one or more products of one or more product types available for purchase via transactions facilitated using, for example, the computer terminal 302. In one non-limiting example, each of the first storage area 312 and the second storage area 316 may include multiple shelves each capable of holding (i.e., storing) multiple products of one or more product types. In other non-limiting examples, each of the first storage area 312 and the second storage area 316 may include lanes arranged in rows in which each row represents a different shelf and in which each lane is capable of holding multiple products of one or more product types.

The computer terminal 302 includes an input/output 318 which includes at least one input component and at least one output component. For example, the input/output 318 may be the user interface 212 shown in FIG. 2. The input component of the input/output 318 is configured to obtain, from a user of the computer terminal 302 (i.e., a consumer initiating a transaction for products available at the primary merchandiser device 304 and the secondary merchandiser device 306), input identifying the products associated with the transaction. The output component of the input/output 318 is configured to output (e.g., for display) information associated with the transaction (e.g., a completion status or total cost), the user (e.g., an identifier or account balance), a product associated with the transaction (e.g., a price or location within a merchandiser device). In one non-limiting example where the computer terminal 302 is a vending interface device integrated on or within the primary merchandiser device 304, the input/output 318 may include one or more physical or virtual keys or buttons configured to receive user selections as input, one or more internal components configured to receive data from an external source (e.g., a near field communication (NFC) reader capable of reading information from a credit card or mobile phone or a network interface configured to obtain data transmitted from a mobile phone), and/or a display configured to visually present, at one or more times, information associated with the transaction or subject products, the primary merchandiser device 304 and/or the secondary merchandiser device 306, the user, or the like.

The first controller 310 is configured to process a first signal to unlock a lock mechanism of the first storage area 312. The second controller 314 is configured to process a second signal to unlock a lock mechanism of the second storage area 316. The first signal and the second signal are, include, represent, or otherwise correspond to information digitally transmitted for processing by the first controller 310 and the second controller 314, respectively.

Based on (e.g., in response to) the input authenticating the user for the transaction, the first signal is generated (e.g., produced, determined, derived, or otherwise made available for processing). In particular, the first signal is generated at the computing device 308 based on the input obtained via the input/output 318. The first signal is, includes, represents, or otherwise corresponds to information that, when processed by the first controller 310, is configured to cause the first controller 310 to unlock a lock mechanism of the first storage area 312 to enable access by the user to the first storage area 312. The second signal is generated at the computing device 308 using a copy of the first signal. For example, the second signal may be generated by replacing information specific to the primary merchandiser device 304 (e.g., information related to the first controller 310 or the first storage area 312) with information specific to the secondary merchandiser device 306 (e.g., information related to the second controller 314 or the second storage area 316). Thus, the second signal is, includes, represents, or otherwise corresponds to information that, when processed by the second controller 314, is configured to cause the second controller 314 to unlock a lock mechanism of the second storage area 316 to enable access by the user to the second storage area 316. The second signal is transmitted to the second controller 314 by the computing device 308.

In one non-limiting example of the joined cabinet system 300, the computer terminal 302 obtains input authenticating the user for a transaction initiated via the computer terminal 302. The computing device 308 is in communication with the computer terminal 304, the first controller 310 is in communication with the computing device 308, and the first storage area 312 stores a first set of products. The second controller 314 is in communication with the computing device 308 and the second storage area 316 stores a second set of products. Based on the input, the computing device 308 is configured to transmit, to the first controller 310, a first signal configured to cause the first controller 310 to unlock a lock mechanism of the first storage area 312 to enable access by the user to the first storage area 312, and transmit, to the second controller 314, a second signal configured to cause the second controller 314 to unlock a lock mechanism of the second storage area 316 to enable access by the user to the second storage area 316. In another non-limiting example of the joined cabinet system 300, where the computing device 308 is omitted, the primary merchandiser device 304 (e.g., via the first controller 310) is configured to, based on the input authenticating the user for the transaction, transmit, to the first controller 310, a first signal configured to cause the first controller 310 to unlock a lock mechanism of the first storage area 312 to enable access by the user to the first storage area 312, and transmit, to the second controller 314, a second signal configured to cause the second controller 314 to unlock a lock mechanism of the second storage area 316 to enable access by the user to the second storage area 316.

In some implementations, the computing device 308 determines, based on input obtained via the input/output 318, products associated with the transaction initiated at the computer terminal 302 and that the products correspond to the primary merchandiser device 304 and to the secondary merchandiser device 306. For the purpose of discussion, the first storage area 312 may be understood to store a first set of products and the second storage area 316 may be understood to store a second set of products. In some such implementations, the computing device 308 determines that the products associated with the transaction correspond to the primary merchandiser device 304 and to the secondary merchandiser device 306 based on the products including a first product of the first set of products and a second product of the second set of products. For example, the computing device 308 may maintain a record of the sets of products stored by each merchandiser device of the joined cabinet system 300 (e.g., via planogram data locally stored at the computing device 308 or accessible via an external computing device, for example, one of the server device 106, the operator device 108, or the management device 110 shown in FIG. 1). The computing device 308 may thus determine that the products associated with the transaction include a first product of the first set of products and a second product of the second set of products based on such a record. In another example, the computing device 308 may obtain input from the computer terminal 302 (i.e., via the input/output 318) identifying the first product and the second product. In such a case, the input may be user selections of the first product and the second product, for example, made at the computer terminal 302 or communicated to the computer terminal 302 via a mobile device.

The primary merchandiser device 304 and/or the secondary merchandiser device 306 may include one or more cameras configured to capture and/or stream images and/or video. In particular, as illustrated, the primary merchandiser device 304 includes one or more cameras 320 and the secondary merchandiser device 306 includes one or more cameras 322. The one or more cameras 320, which may also be referred to as one or more first cameras 320, and the one or more second cameras 322, which may also be referred to as one or more second cameras 322, may include the same number or different numbers of cameras. In one non-limiting example, the one or more first cameras 320 and the one or more second cameras 322 may each include six cameras respectively located at various positions within the primary merchandiser device 304 and the secondary merchandiser device 306.

In particular, the one or more first cameras 320 are positioned within the first storage area 312 and the one or more second cameras 322 are positioned within the second storage area 316. Thus, the one or more first cameras 320 are configured to capture images or video of the first storage area 312 and the one or more second cameras 322 are configured to capture images or video of the second storage area 316. The first controller 310 activates the one or more first cameras 320 based on the first signal and the second controller 314 activates the one or more second cameras 322 based on the second signal. Accordingly, the activation of the one or more first cameras 320 and of the one or more second cameras 322 is directly or indirectly based on (e.g., responsive to) the input obtained via the input/output 318.

The one or more first cameras 320 and the one or more second cameras 322 are configured to capture images or video used to identify products associated with the transaction, for example, based on those products being retrieved from the first storage area 312 and the second storage area 316 in connection with the transaction initiated at the computer terminal 302. For example, a computer vision processing aspect (e.g., at the computing device 308) may process the images or frames of the video to detect a product retrieval depicted within the images or frames. The computer vision processing aspect may then to perform object recognition against the detected product within the images to identify the product. For example, performing the object recognition can include searching a data store (e.g., a data base or other store of images of products) based on the detection of the product within the images or frames to produce output corresponding to identifying information associated with contents of the data store. The data store may, for example, be locally stored at the computing device 308 or another aspect at the joined cabinet system 300 (e.g., the computer terminal 302) or remotely stored at a computer external to the joined cabinet system 300 (e.g., a server device, such as the server device 106 shown in FIG. 1).

The obtaining of images and/or video captured using one or more cameras activated for a transaction with the joined cabinet system 300 may occur at one or more times. In some cases, some or all of the images and/or video may be transmitted while the transaction remains in progress. For example, images and/or video may be streamed either in real-time or with a delay during the transaction, such as based on the capture of such images and/or video. In another example, images and/or video may be transmitted (e.g., to the computing device 308 or another device, such as one of the server device 106, the operator device 108, or the management device 110 shown in FIG. 1) at an end of the transaction.

The one or more first cameras 320 and the one or more second cameras 322 may be movably configured within and between the primary merchandiser device 304 and the secondary merchandiser device 306. For example, each such camera may be a dedicated hardware module that may use wired or wireless communication to operate in connection with its respective merchandiser device. In some cases, some or all of one or more first cameras 320 and/or the one or more second cameras 322 may include motors configured to enable movement of image sensors of the cameras. For example, a motor may enable the locally-operated or remotely-operated movement of a camera module by moving its image sensor to have a different field of view, thereby enabling greater variety in visibility of the merchandiser device within which it is positioned. In some cases, such movement may be controlled via a device at the premises at which the joined cabinet system 300 operates (e.g., one or both of the operator device 108 or the management device 110 shown in FIG. 1), for example, via a web-based dashboard or like interface. In other cases, such movement may be controlled via automated software intelligence, for example, a computer vision aspect as described above or an artificial intelligence software unit, which may calculate optimal camera positionings according to candidate fields of view of the respective cameras.

The merchandiser devices of the joined cabinet system 300 may each be one of a refrigerated merchandiser device or an ambient merchandiser device. A refrigerated merchandiser device generally is a merchandiser device which includes hardware capable of controlling an internal temperature thereof and thus operates to, in relevant part, refrigerate (and thus maintaining the refrigeration of) products stored in the storage area thereof. An ambient merchandiser device generally is a merchandiser device which does not include (i.e., which omits) hardware capable of such internal temperature control and thus does not operate to, in relevant part, refrigerate products stored in the storage area thereof. In one non-limiting example, the primary merchandiser device 304 is a refrigerated merchandiser device and the secondary merchandiser device 306 is an ambient merchandiser device. In other examples, the primary merchandiser device 304 and the secondary merchandiser device 306 may both be a refrigerated merchandiser device or may both be an ambient merchandiser device. In still other examples, where the joined cabinet system 300 includes other merchandiser devices in addition to the primary merchandiser device 304 and the secondary merchandiser device 306, variations of refrigerated merchandiser devices and/or ambient merchandiser devices are possible. Similarly, dimensions are not limited for the primary merchandiser device 304, the secondary merchandiser device 306, or any other merchandiser devices of the joined cabinet system and, as such, any such merchandiser device may be provided in one or more sizes (e.g., a standard size having a standard storage area or a wide body size having a large storage area that is larger than a standard storage area of a standard size merchandiser device).

In the example shown, the primary merchandiser device 304 includes temperature control hardware 324 while the secondary merchandiser device 306 does not. Thus, in the example shown, the primary merchandiser device 304 is a refrigerated merchandiser device and the secondary merchandiser device is an ambient merchandiser device. The temperature control hardware 324 is or includes hardware capable of controlling an internal temperature of the primary merchandiser device 304 (i.e., of the first storage area 312). The temperature control hardware 324 may, for example, be or include a compressor used for refrigeration alongside other hardware (generally, physical components of a mechanical, electrical, or other nature) usable to configure the primary merchandiser device 304 for refrigeration and maintenance of refrigerated products for storage therein.

In some implementations, the computing device 308 may be configured to cause the first controller 310 to use the temperature control hardware 324 to change an internal temperature of the secondary merchandiser device 306, for example, via a physical connection between the first storage area 312 and the second storage area 316 or otherwise between the temperature control hardware 324 directly and the second storage area 316. Thus, in some cases, the primary merchandiser device includes hardware for controlling an internal temperature of the primary merchandiser device and the computing device 308 causes the temperature control hardware 324 to change an internal temperature of the secondary merchandiser device 306.

For example, the secondary merchandiser device 306 may include a temperature sensor usable to measure the internal temperature of the second storage area 316. The second controller 314 may, at one or more times, independent of transactions at the joined cabinet system 300, obtain temperature sensor output indicating the internal temperature of the second storage area 316 from the temperature sensor and transmit that temperature sensor output to the computing device 308. The computing device 308 may then determine whether the temperature sensor output meets a threshold. For example, the threshold may indicate or otherwise correspond to a temperature for the second storage area 316 to maintain (e.g., for food safety or like purposes). Meeting the threshold may thus include the temperature sensor output being below the threshold. Based on a determination that the temperature sensor output meets the threshold, the computing device 308 may cause the temperature control hardware 322 to change the internal temperature of the secondary merchandiser device 306. For example, the computing device 308 may transmit a signal to the first controller 310 to cause the first controller 310 to activate the temperature control hardware 322 for use with the secondary merchandiser device 306. For example, activating the temperature control hardware 322 for use with the secondary merchandiser device 306 may include causing the temperature control hardware 322 to direct cold air produced via the temperature control hardware 322 to the second storage are 316, such as via the physical connection between the first storage area 312 and the second storage area 316 or between the temperature control hardware 324 directly and the second storage area 316.

In some implementations, the computing device 308 may be the computer terminal 302. For example, the computing device 308 may be omitted and the operations thereof may instead be performed at or otherwise by the computer terminal 302. In such a case, for example, the computer terminal 302, based on an authentication of the user for the transaction, transmits the first signal to the first controller 310 and the second signal to the second controller 314.

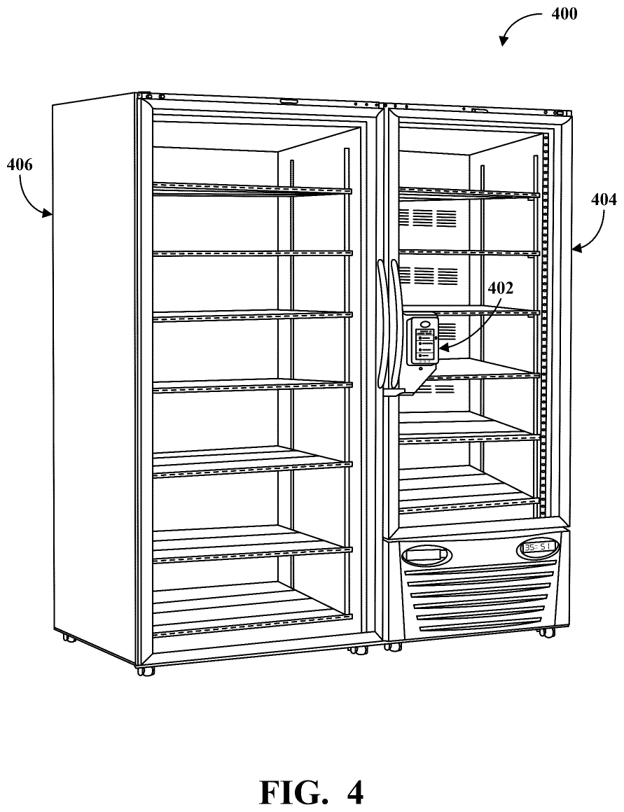

FIG. 4 is an illustration of an example configuration of joined primary and secondary cabinets 400 of a joined cabinet system, which may, for example, be the joined cabinet system 300 shown in FIG. 3. The joined primary and secondary cabinets 400 include a computer terminal 402, a primary merchandiser device 404, and a secondary merchandiser device 406, which may, for example, respectively be the computer terminal 302, the primary merchandiser device 304, and the secondary merchandiser device 306 shown in FIG. 3. In the example shown, the primary merchandiser device 404 is a refrigerated merchandiser device and the secondary merchandiser device 406 is an ambient merchandiser device, and the computer terminal 402 is a vending interface device integrated on or within the primary merchandiser device 404.

In an example use case, a person seeking to purchase goods for consumption (i.e., a user) approaches the computer terminal 402. The person taps their credit card or mobile phone to an NFC reader of the computer terminal 302 to cause the computer terminal 302 to obtain input usable to determine whether to authenticate the user for a transaction for products at the primary merchandiser device 404 and the secondary merchandiser device 406. Determining whether to authenticate the user for the transaction may, for example, include the computer terminal 402 verifying that the user has access to an account to which a transaction cost may be charged. For example, the computer terminal 402 can verify that the user has access to an account to which the transaction may be charged by communicating with an external server (e.g., of a credit or debit payment processing system) to verify that a credit or debit account associated with the user and identified by the computer terminal 402 (e.g., via an NFC reader or other sensor component thereof) is available to receive a new charge. In another example, the computer terminal 402 can verify that the user has access to an account to which the transaction may be charged via local processing (e.g., by accessing a locally stored record associated with an account of the user for a platform with which the joined primary and secondary cabinets are associated).

Based on an authentication of the user for the transaction (e.g., in response to the computer terminal 402 determining to authenticate the user for the transaction), the computer terminal 402 transmits an instruction to a computing device of the primary merchandiser device 404 to cause the computing device to transmit a first signal to a first controller of the primary merchandiser device 404 and to transmit a second signal to a second controller of the secondary merchandiser device 406. The first signal is configured to cause a lock mechanism of a first storage area of the primary merchandiser device 404 to unlock to enable the user to access one or more products from within the first storage area. The second signal is configured to cause a lock mechanism of a second storage area of the secondary merchandiser device 406 to unlock to enable the user to access one or more products from within the second storage area.

The first signal and the second signal are further configured to activate one or more cameras within each of the primary merchandiser device the secondary merchandiser device (e.g., the one or more first cameras 320 and the one or more second cameras 322 shown in FIG. 3). The activation of the one or more cameras within each of the primary merchandiser device the secondary merchandiser device enables those one or more cameras to begin capturing and/or streaming images and/or video depicting the first storage area and the second storage area. Thus, in this use case example, the one or more cameras within the primary merchandiser device 404 capture images or video of the user as they reach into each of the first storage area and the second storage area to identify the products that the user retrieves from each of the first storage area and the second storage area.

The products depicted as being retrieved within the images captured using the one or more cameras of each of the primary merchandiser device 404 and the secondary merchandiser device 406 are then identified by an object recognition process performed locally at the computing device of the primary merchandiser device 404. Costs for those retrieved products are then determined locally at the computing device of the primary merchandiser device 404 (e.g., using locally stored cost data or by the computing device, by itself or using the computer terminal 402, accessing an external computer). Those costs are then applied against the account used to authenticate the user for the transaction. The user may then proceed to consume the retrieved products in their desired manner.

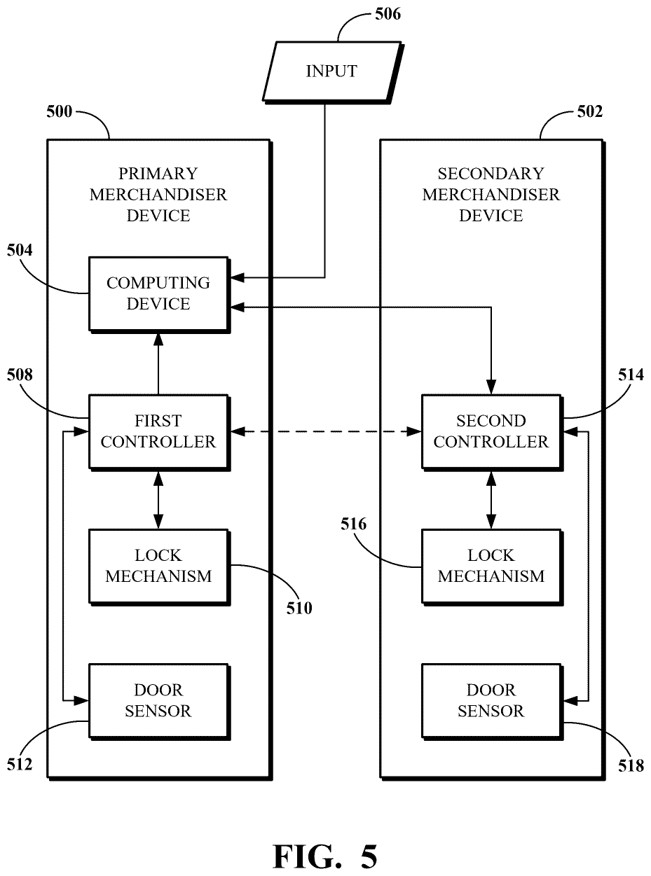

FIG. 5 is a block diagram of example functionality of joined primary and secondary cabinets of a joined cabinet system, which may, for example, be the joined cabinet system 300 shown in FIG. 3. In particular, as shown are a primary merchandiser device 500 and a secondary merchandiser device 502, which may, for example, respectively be the primary merchandiser device 304 and the secondary merchandiser device 306 shown in FIG. 3 or the primary merchandiser device 404 and the secondary merchandiser device 406 shown in FIG. 4. The primary merchandiser device 500 includes a computing device 504, which may, for example, be the computing device 308 shown in FIG. 3. The computing device 504 is configured to obtain input 506 authenticating a user for a transaction. The input 506 may, for example, be obtained from a computer terminal in communication with the computing device 504. For example, the computer terminal may be the computer terminal 302 shown in FIG. 3 or the computer terminal 402 shown in FIG. 4.

The primary merchandiser device 500 further includes a first controller 508, a lock mechanism 510, and a door sensor 512. Similarly, the secondary merchandiser device 502 further includes a second controller 514, a lock mechanism 516, and a door sensor 518. The first controller 508 and the second controller 514 may, for example, respectively be the first controller 310 and the second controller 314 shown in FIG. 3.

The lock mechanisms 510 and 516 are hardware components configured to restrict access to doors of the primary merchandiser device 500 and the secondary merchandiser device 502, respectively. For example, the lock mechanisms 510 and 516 may each be or include one or more of an electromechanical lock or an electromagnetic lock. In some cases, the lock mechanisms 510 and 516 may include dedicated access control units and/or accessory hardware. The lock mechanism 510 is configured to unlock based on a first signal from the first controller 508 and the lock mechanism 516 is configured to unlock based on a second signal from the second controller 514. The first and second signals are transmitted from the computing device 504. In particular, the first controller 508 is configured to execute data transmitted within the first signal to cause the lock mechanism 510 to unlock (i.e., disengage) and the second controller 514 is configured to execute data transmitted within the second signal to cause the lock mechanism 516 to unlock (i.e., disengage). The data transmitted within each of the first signal and the second signal may be of one or more formats, types, or the like.

The door sensors 512 and 518 are sensors configured to measure open or closed states of doors of the primary merchandiser device 500 and the secondary merchandiser device 502, respectively. For example, the door sensors 512 and 518 may each be or include one or more of a mechanical push sensor, an electromechanical sensor, or an electromagnetic sensor. The door sensors 512 and 518 may be configured to generate output representing such measurements on a periodic or event basis. For example, the door sensors 512 and 518 may generate the output on a periodic basis such as a defined time interval (e.g., once per second or once every five seconds). In another example, the door sensors 512 and 518 may generate the output on an event basis such as upon an unlocking or relocking of respective doors of the primary merchandiser device 500 and the secondary merchandiser device 502.

Based on an authentication of a user for a transaction associated with the primary merchandiser device 500 and/or the secondary merchandiser device 502, as indicated via the input 506, the computing device 504 transmits the first signal to the first controller 508 and the second signal to the second controller 514. The first signal indicates to the first controller 508 to change a first registry bit associated with the primary merchandiser device 500 and the second signal indicates to the second controller 514 to change a second registry bit associated with the secondary merchandiser device 502. In particular, the first registry bit is data used with the lock mechanism 510 to control a locking or unlocking of the lock mechanism 510 and the second registry bit is data used with the lock mechanism 516 to control a locking or unlocking of the lock mechanism 516. The first signal may thus cause the first registry bit to change (e.g., from a 0 value to a 1 value) and the second signal may thus cause the second registry bit to change (e.g., from a 0 value to a 1 value). The changed values of the first and second registry bits cause the lock mechanisms 510 and 516, respectively, to unlock.

The first signal and the second signal may be transmitted in parallel or in series. In some cases, the lock mechanism 510 may unlock before the lock mechanism 516 unlocks. In other cases, the lock mechanism 516 may unlock before the lock mechanism 510 unlocks. In still other cases, the lock mechanism 510 and the lock mechanism 516 may be simultaneously unlocked. For example, the first signal and the second signal may cause a simultaneous unlocking of the lock mechanism 510 and the lock mechanism 516.

The computing device 504 monitors and maintains statuses of the lock mechanism 510, the door sensor 512, the lock mechanism 516, and the door sensor 518. The statuses of the lock mechanism 510 and the lock mechanism 516 indicate whether they are locked (i.e., engaged) or unlocked (i.e., disengaged). The statuses of the door sensor 512 and the door sensor 518 indicate whether the doors associated therewith are open or closed. The computing device 504 uses this various status information in connection with the transaction for which the user is authenticated. The computing device 504 uses this status information to determine (i.e., infer) a start of the transaction and an end of the transaction.

In particular, the statuses of the lock mechanism 510 and of the door sensor 512 are obtained by the first controller 508 and the statuses of the lock mechanism 516 and of the door sensor 518 are obtained by the second controller 514. The computing device 504 then obtains the statuses of the lock mechanism 510 and of the door sensor 512 from the first controller 508 and the statuses of the lock mechanism 516 and of the door sensor 518 from the second controller 514. For example, the computing device 504 may obtain the statuses of the lock mechanism 510 and of the door sensor 512 from the first controller 508 via one or more third signals and the statuses of the lock mechanism 516 and of the door sensor 518 from the second controller 514 via one or more fourth signals.

One or more of the statuses of the lock mechanism 510, the door sensor 512, the lock mechanism 516, and the door sensor 518 may be obtained at a given time. For example, in some cases, the computing device 504 may obtain the one or more third signals from the first controller 508 and the one or more fourth signals from the second controller 514 at the same time (i.e., simultaneously). In another example, the computing device 504 may obtain the one or more third signals from the first controller 508 and the one or more fourth signals from the second controller 514 at different times.

In some implementations, the computing device 504 may obtain each of the one or more third signals at the same time. In some implementations, the computing device 504 may obtain one or more of the third signals at a first time and others the third signals at one or more other times. In some implementations, the computing device 504 may obtain each of the one or more fourth signals at the same time. In some implementations, the computing device 504 may obtain one or more of the fourth signals at a first time and others the third signals at one or more other times.

In some implementations, the computer terminal from which the input 506 is obtained may obtain the statuses of the lock mechanism 510 and of the door sensor 512 from the first controller 508 via the one or more third signals and the statuses of the lock mechanism 516 and of the door sensor 518 from the second controller 514 via the one or more fourth signals and thereafter transmit the statuses of the lock mechanism 510, the door sensor 512, the lock mechanism 516, and the door sensor 518 to the computing device 504. Thus, in such a case, the computer terminal obtains status information for one or more of the lock mechanism 510, the door sensor 512, the lock mechanism 516, or the door sensor 518 at a given time and transmits the status information to the computing device 504.

In one example, the computing device 504 determines the start of the transaction based on a determination that a status of the lock mechanism 510 and of the lock mechanism 516 is unlocked and that a status of the door sensor 514 and of the door sensor 518 is closed. In such a case, the computing device 504 determines that the transaction has started based on the execution of the first and second signals respectively by the first controller 508 and the second controller 514, resulting in the unlocking of the lock mechanism 510 and the lock mechanism 516, regardless of whether the doors of the primary merchandiser device 500 or the secondary merchandiser device 502 have yet been opened.

In another example, the computing device 504 determines the start of the transaction based on a determination that a status of the lock mechanism 510 and of the lock mechanism 516 is unlocked and that a status of one or both of the door sensor 514 or the door sensor 518 is open. In such a case, the computing device 504 determines that the transaction has started based on the execution of the first and second signals respectively by the first controller 508 and the second controller 514, resulting in the unlocking of the lock mechanism 510 and the lock mechanism 516, and the opening of at least one of the doors of the primary merchandiser device 500 or the secondary merchandiser device 502.

In yet another example, the computing device 504 determines the end of the transaction based on a determination that a status of both of the door sensor 514 or the door sensor 518 is closed for at least a threshold period of time (e.g., five or ten seconds). In such a case, the computing device 504 determines that the transaction has ended based on inactivity of the doors of the primary merchandiser device 500 and of the secondary merchandiser device 502 for at least the threshold period of time.

In response to determining an end of the transaction, the computing device 504 transmits another signal to each of the first controller 508 and the second controller 514 (e.g., a fifth signal to the first controller 508 and a sixth signal to the second controller 514). The first controller 508 executes the fifth signal to cause the lock mechanism 510 to lock (i.e., engage). The second controller 514 executes the sixth signal to cause the lock mechanism 516 to lock (i.e., engage). The computing device 504, based on such locking of the lock mechanism 510 and the lock mechanism 516, may receive (e.g., via the first controller 508 and the second controller 514, respectively) updated status information of the lock mechanism 510 and of the lock mechanism 518 to verify that both are locked.

In some implementations, the computing device 504 uses timings of the one or more third signals and of the one or more fourth signals to determine whether a suspected transaction fraud event occurs. Generally, a suspected transaction fraud event refers to a situation in which one or more products are retrieved from one or both of the primary merchandiser device 500 or the secondary merchandiser device 502 in a manner that is intended to prevent a cost of those one or more products from being applied against an account of the user. While this may in some cases be unintended by the user, it may be a deliberate attempt to conceal a true number of retrieved products in order to reduce a total cost applied against a user account.

For example, a suspected transaction fraud event may be determined where object recognition performed against images or video captured using one or more cameras of the joined cabinet system detects that a number of a given product retrieved from a merchandiser device of the joined cabinet system does not align with an expected number of the given product that has been retrieved from the merchandiser device. For example, the one or more cameras of the primary merchandiser device 500 may perform object detection at a first time to determine a first number of products of a given product, such as before a transaction or at a start of a transaction. During the transaction, a second number of products is detected as being retrieved from the primary merchandiser device 500, as mentioned above. Thereafter, the one or more cameras may perform another object detection at a second time after the product retrieval to determine a third number of products of the given product. A suspected transaction fraud event may be determined where a difference between the third count and the first count does not equal the second count.

The computing device 504 can monitor a pending time of a transaction based on a determination that the transaction has started. Where the computing device 504 determines that the pending time meets a threshold (e.g., thirty seconds or one minute), the computing device 504 may determine a suspected transaction fraud event (i.e., the computing device 504 may determine that a suspected transaction fraud event is occurring) in connection with the joined cabinet system. In such a case, the computing device 504 may take one or more actions to address the suspected transaction fraud event including, for example, outputting an audio, visual, or audiovisual alert (e.g., at the computer terminal or an operator or management device, for example, the operator device 108 or the management device 110 shown in FIG. 1) to indicate the suspected transaction fraud event (e.g., to the user or an operator or manager of the joined cabinet system or otherwise of a store or location at which the joined cabinet system operates).

In some cases, the computing device 504, based on a determination of a suspected transaction fraud event, may transmit signals to the first controller 508 and to the second controller 514 to cause the first controller 508 to lock the lock mechanism 510 and to cause the second controller 514 to lock the lock mechanism 516. In such a case, the locking is performed to prevent further suspicious activity during the transaction and the user may be prompted (e.g., at the computer terminal) to initiate a new transaction should they wish to purchase other products available at the joined cabinet system.

In some implementations, the second controller 514 is in direct communication with the first controller 508 instead of with the computing device 504. For example, the second signal described above as being transmitted directly from the computing device 504 to the second controller 514 may instead be transmitted from the computing device 504 to the first controller 508 and relayed to the second controller 514 via the first controller 508. In some such implementations, the first controller 508, instead of the second controller 514, may communicate with the lock mechanism 516 and the door sensor 518 to obtain status information of the lock mechanism 516 and of the door sensor 518. For example, in such a case, the first controller 508 may relay that status information to the computing device 504 and receive one or more signals from the computing device 504 that the first controller 508 then relays to the second controller 514, for example, to cause the lock mechanism 516 to lock or unlock.

In some implementations, the joined cabinet system as described with respect to FIG. 5 may perform camera scaling. Generally, camera scaling refers to the scaled activation of one or more cameras of the joined cabinet system (i.e., within one or both of the primary merchandiser device 500 or the secondary merchandiser device 502). For example, rather than activating all of one or more first cameras within a first storage area of the primary merchandiser device 500 (e.g., the one or more first cameras 320 shown in FIG. 3) and one or more second cameras within a second storage area of the secondary merchandiser device 522 (e.g., the one or more second cameras 322 shown in FIG. 3) based on the first and second signal as described above, ones of the one or more first cameras and/or the one or more second cameras may be selectively activated at one or more times during a transaction.

For example, the activation of cameras of the joined cabinet system may be based on status information transmitted to the computing device 504. The computing device 504 may transmit additional signals to the first controller 508 to indicate to the first controller 508 to activate select ones of the one or more first cameras during the transaction and may similarly transmit additional signals to the second controller 514 to indicate to the second controller 514 to activate select ones of the one or more first cameras during the transaction. In some such implementations, the additional signals may be transmitted based on status information of the lock mechanisms 510 and 516 and/or of the door sensors 512 and 518.

In one non-limiting example, the computing device 504 may determine that the status of the lock mechanism of the primary merchandiser device 500 is unlocked and that the status of the door sensor 512 is open. Based on that status information, the computing device 504 may transmit a signal to the first controller 508 to cause the first controller 508 to activate one or more cameras within the first storage area of the primary merchandiser device 500. For example, the computing device 504 may transmit an additional signal to the first controller 508 to cause the first controller 508 to activate one or more first cameras positioned within the first storage area of the primary merchandiser device 500 based on the computing device 504 determining, based on status information of the lock mechanism 510 and of the door sensor 512, that the lock mechanism 510 is unlocked and the door of the primary merchandiser device 500 is open.

In some implementations, an artificial intelligence model may be trained and deployed for inference use in determining statuses of some or all of the lock mechanism 510, the door sensor 512, the lock mechanism 516, or the door sensor 518. For example, the artificial intelligence model may be a neural network, such as a convolutional neural network or artificial neural network, or another classification aspect. The artificial intelligence model may be accessed locally at the computing device 504 or remotely, for example, at a server device (e.g., the server device 106). Training the artificial intelligence model can include obtaining a training data set including data representing various states and conditions of the lock mechanism 510, the door sensor 512, the lock mechanism 516, and/or the door sensor 518, or of similar lock mechanisms and/or door sensors, and extrapolating upon such data to recognize patterns in classifications of statuses therefor.

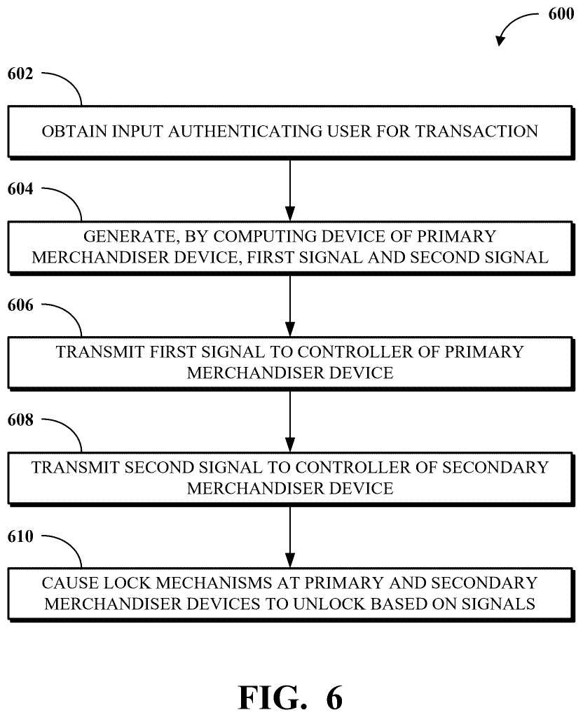

To further describe some implementations in greater detail, reference is next made to examples of techniques used by a joined cabinet system. FIG. 6 is a flowchart of an example of a technique 600 for secondary cabinet control via a joined primary cabinet. The technique 600 can be executed using computing devices, such as those included within or otherwise using the systems, software, and devices described with respect to FIGS. 1-5. In one non-limiting example, the technique 600 may be performed by the computing device 308 shown in FIG. 3 or the computing device 504 shown in FIG. 5. The technique 600 can be performed, for example, by executing a machine-readable program or other computer-executable instructions, such as routines, instructions, or programs described according to one or more of various computer languages (e.g., Java, JavaScript, or C++), or other such routines or instructions. The steps, or operations, of the technique 600, or of any other technique, method, process, or algorithm described in connection with the implementations disclosed herein, can be implemented directly in hardware, firmware, software executed by hardware, circuitry, or a combination thereof.

At 602, input authenticating a user for a transaction is obtained. The input is obtained via a computer terminal. The computer terminal may, for example, be a vending interface device integrated on or within a primary merchandiser device of a joined cabinet system or a personal mobile device.

At 604, a first signal and a second signal are generated. The first and second signals are generated based on the input authenticating the user for the transaction. Generating the first and second signals can, for example, include generating, producing, determining, identifying, selecting, or otherwise preparing information which may be communicated between computing aspects (e.g., a computing device and a controller). In particular, generating the first and second signals can include preparing information that will configure controllers of merchandiser devices of the joined cabinet system to unlock lock mechanisms of those merchandiser devices. The first signal indicates to the first controller to change a first registry bit associated with the primary merchandiser device and the second signal indicates to the second controller to change a second registry bit associated with the secondary merchandiser device. In some cases, the first signal is generated based on the input the second signal is generated using a copy of the first signal.

At 606, the first signal is transmitted to a controller of the primary merchandiser device. The first signal is configured to cause a first controller of the primary merchandiser device to unlock a lock mechanism of a first storage area of the primary merchandiser device to enable access by the user to the first storage area.

At 608, the second signal is transmitted to a controller of a secondary merchandiser device. The second signal is configured to cause a second controller of the secondary merchandiser device to unlock a lock mechanism of a second storage area of the secondary merchandiser device to enable access by the user to the second storage area.

At 610, lock mechanisms at the primary and secondary merchandiser devices are caused to unlock based on the first and second signals. In particular, the lock mechanism of the first storage area is caused to unlock based on the first signal and the lock mechanism of the second storage area is caused to unlock based on the second signal. In some cases, the lock mechanism of the first storage area and the lock mechanism of the second storage area are simultaneously unlocked.

In some implementations, the technique 600 includes causing an activation of one or more cameras of the joined cabinet system for the transaction. For example, the primary merchandiser device may include one or more first cameras configured to capture images or video of the first storage area and the secondary merchandiser device may include one or more second cameras configured to capture images or video of the second storage area. The first controller may activate the one or more first cameras based on the first signal (or another signal transmitted to the first controller) and the second controller may activate the one or more second cameras based on the second signal (or another signal transmitted to the second controller). In some such implementations, the technique 600 includes, based on the activation of the one or more first cameras and the one or more second cameras, determining that the transaction is for one or more first products from the first storage area and one or more second products from the second storage area.

In some implementations, the technique 600 includes causing temperature control hardware of the primary merchandiser device to change an internal temperature of the secondary merchandiser device. For example, the primary merchandiser device may include hardware (i.e., the temperature control hardware) for controlling an internal temperature of the primary merchandiser device. The secondary merchandiser device may include a temperature sensor. Based on output of the temperature sensor meeting a threshold, the hardware may be caused to change the internal temperature of the secondary merchandiser device.

The technique 600 is described with respect to a joined cabinet system that includes a primary merchandiser device and a secondary merchandiser device. However, in some implementations, a joined cabinet system with which the technique 600 may be used may instead include multiple secondary merchandiser devices. In such a case, the technique 600 scales to use multiple second signals, each corresponding to a different one of the secondary merchandiser devices, for the daisy chained control as disclosed herein.

Although the technique 600 is described herein as showing a series of operations for clarity, implementations of the technique 600, or of any other method, technique, process, and/or algorithm described in connection with the implementations disclosed herein, can be performed in various orders and/or concurrently. For example, in some cases, the first signal and the second signal may be simultaneously transmitted to the respective controllers. In another example, in other cases, the second signal may be transmitted to the controller of the secondary merchandiser device before the first signal is transmitted to the controller of the primary merchandiser device. Additionally, operations in accordance with this disclosure can be performed with other operations not presented and described herein. Furthermore, one or more aspects of the systems and techniques described herein can be omitted.

The implementations of this disclosure describe methods, systems, devices, apparatuses, and non-transitory computer readable media for secondary cabinet control via a joined primary cabinet. Thus, while specific claims may recite a given article (e.g., a system), the applicable limitations thereof shall be understood to be supported by other claim article types (e.g., a method or an apparatus) such that complete support for other such claim article types is recognized and present.

In some implementations, a joined cabinet system comprises: a computer terminal that obtains input authenticating a user for a transaction; a primary merchandiser device including a computing device in communication with the computer terminal, a first controller in communication with the computing device, and a first storage area; and a secondary merchandiser device including a second controller in communication with the computing device and a second storage area, wherein, based on the input, the computing device is configured to: transmit, to the first controller, a first signal configured to cause the first controller to unlock a lock mechanism of the first storage area to enable access by the user to the first storage area; and transmit, to the second controller, a second signal configured to cause the second controller to unlock a lock mechanism of the second storage area to enable access by the user to the second storage area.

In some implementations of the joined cabinet system, the primary merchandiser device and the secondary merchandiser device are daisy chained via the computing device.

In some implementations of the joined cabinet system, the first signal is generated based on the input the second signal is generated using a copy of the first signal.

In some implementations of the joined cabinet system, the first signal indicates to the first controller to change a first registry bit associated with the primary merchandiser device and the second signal indicates to the second controller to change a second registry bit associated with the secondary merchandiser device.

In some implementations of the joined cabinet system, the lock mechanism of the first storage area and the lock mechanism of the second storage area are simultaneously unlocked via the changes to the first registry bit and the second registry bit.

In some implementations of the joined cabinet system, the primary merchandiser device is a refrigerated merchandiser device and the secondary merchandiser device is an ambient merchandiser device.

In some implementations of the joined cabinet system, the primary merchandiser device includes one or more first cameras configured to capture images or video of the first storage area and the secondary merchandiser device includes one or more second cameras configured to capture images or video of the second storage area.

In some implementations of the joined cabinet system, the first controller activates the one or more first cameras based on the first signal and the second controller activates the one or more second cameras based on the second signal, and wherein, based on the activation of the one or more first cameras and the one or more second cameras, the computing device is configured to determine that the transaction is for one or more first products from the first storage area and one or more second products from the second storage area.

In some implementations of the joined cabinet system, the primary merchandiser device includes hardware for controlling an internal temperature of the primary merchandiser device and the computing device causes the hardware to change an internal temperature of the secondary merchandiser device.

In some implementations of the joined cabinet system, the secondary merchandiser device includes a temperature sensor and the computing device causes the hardware to change the internal temperature of the secondary merchandiser device based on output of the temperature sensor meeting a threshold.

In some implementations, a joined cabinet system comprises: a primary merchandiser device including a computing device, a first controller in communication with the computing device, and a first storage area; and a secondary merchandiser device including a second controller in communication with the computing device and a second storage area, wherein, based on input authenticating a user for a transaction, the computing device is configured to: transmit, to the first controller, a first signal configured to cause the first controller to unlock a lock mechanism of the first storage area to enable access by the user to the first storage area; and transmit, to the second controller, a second signal configured to cause the second controller to unlock a lock mechanism of the second storage area to enable access by the user to the second storage area.

In some implementations of the joined cabinet system, the first signal and the second signal are generated based on the input and the input is obtained from a computer terminal at which the transaction is initiated.

In some implementations of the joined cabinet system, the computer terminal is a vending interface device integrated on or within the primary merchandiser device.

In some implementations of the joined cabinet system, the computer terminal is a personal mobile device.

In some implementations of the joined cabinet system, the primary merchandiser device and the secondary merchandiser device are daisy chained via the computing device.

In some implementations of the joined cabinet system, the first signal and the second signal cause a simultaneous unlocking of the lock mechanism of the first storage area and the lock mechanism of the second storage area.

In some implementations, a joined cabinet system comprises: a primary merchandiser device including a computing device, a first controller, and a first storage area; and a secondary merchandiser device including a second controller and a second storage area, wherein the first controller, via a first signal transmitted from the computing device based on input authenticating a user for a transaction, unlocks a lock mechanism of the first storage area to enable access to the first storage area, wherein the second controller, via a second signal transmitted from the computing device based on the input, unlocks a lock mechanism of the second storage area to enable access to the second storage area, and wherein the primary merchandiser device and the secondary merchandiser device are daisy chained via the computing device.

In some implementations of the joined cabinet system, the system comprises: a computer terminal from which the input is obtained.

In some implementations of the joined cabinet system, the system comprises: one or more cameras activated via one or both of the first signal or the second signal, wherein the one or more cameras are configured to capture images or video used to identify products associated with the transaction.

In some implementations of the joined cabinet system, the lock mechanism of the first storage area and the lock mechanism of the second storage area are simultaneously unlocked.

The implementations of this disclosure can be described in terms of functional block components and various processing operations. Such functional block components can be realized by any number of hardware or software components that perform the specified functions. For example, the described implementations can employ various integrated circuit components (e.g., memory elements, processing elements, logic elements, look-up tables, and the like), which can carry out a variety of functions under the control of one or more microprocessors or other control devices. Similarly, where the elements of the described implementations are implemented using software programming or software elements, the systems and techniques can be implemented with any programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques could employ any number of conventional techniques for electronics configuration, signal processing or control, data processing, and the like. The words “mechanism” and “element” are used broadly and are not limited to mechanical or physical implementations, but can include software routines in conjunction with processors, etc.

Likewise, the terms “mechanism,” “module,” or “monitor” as used herein and in the figures may be understood as corresponding to a functional unit implemented using software, hardware (e.g., an integrated circuit, such as an ASIC), or a combination of software and hardware. In certain contexts, such mechanisms, modules, or monitors may be understood to be a processor-implemented software mechanism, processor-implemented software module, or software-implemented monitor that is part of or callable by an executable program, which may itself be wholly or partly composed of such linked mechanisms, modules, or monitors.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While this disclosure has been described in connection with certain implementations, it is to be understood that this disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A joined cabinet system, comprising:
a computer terminal that obtains input authenticating a user for a transaction;
a primary merchandiser device including a computing device in communication with the computer terminal, a first controller in communication with the computing device, and a first storage area; and
a secondary merchandiser device including a second controller in communication with the computing device and a second storage area,
wherein, based on the input, the computing device is configured to:
transmit, to the first controller, a first signal configured to cause the first controller to unlock a lock mechanism of the first storage area to enable access by the user to the first storage area; and
transmit, to the second controller, a second signal configured to cause the second controller to unlock a lock mechanism of the second storage area to enable access by the user to the second storage area.

2. The joined cabinet system of claim 1, wherein the primary merchandiser device and the secondary merchandiser device are daisy chained via the computing device.

3. The joined cabinet system of claim 1, wherein the first signal is generated based on the input the second signal is generated using a copy of the first signal.

4. The joined cabinet system of claim 3, wherein the first signal indicates to the first controller to change a first registry bit associated with the primary merchandiser device and the second signal indicates to the second controller to change a second registry bit associated with the secondary merchandiser device.

5. The joined cabinet system of claim 4, wherein the lock mechanism of the first storage area and the lock mechanism of the second storage area are simultaneously unlocked via the changes to the first registry bit and the second registry bit.

6. The joined cabinet system of claim 1, wherein the primary merchandiser device is a refrigerated merchandiser device and the secondary merchandiser device is an ambient merchandiser device.

7. The joined cabinet system of claim 1, wherein the primary merchandiser device includes one or more first cameras configured to capture images or video of the first storage area and the secondary merchandiser device includes one or more second cameras configured to capture images or video of the second storage area.

8. The joined cabinet system of claim 7, wherein the first controller activates the one or more first cameras based on the first signal and the second controller activates the one or more second cameras based on the second signal, and wherein, based on the activation of the one or more first cameras and the one or more second cameras, the computing device is configured to determine that the transaction is for one or more first products from the first storage area and one or more second products from the second storage area.

9. The joined cabinet system of claim 1, wherein the primary merchandiser device includes hardware for controlling an internal temperature of the primary merchandiser device and the computing device causes the hardware to change an internal temperature of the secondary merchandiser device.

10. The joined cabinet system of claim 9, wherein the secondary merchandiser device includes a temperature sensor and the computing device causes the hardware to change the internal temperature of the secondary merchandiser device based on output of the temperature sensor meeting a threshold.

11. A joined cabinet system, comprising:
a primary merchandiser device including a computing device, a first controller in communication with the computing device, and a first storage area; and
a secondary merchandiser device including a second controller in communication with the computing device and a second storage area,
wherein, based on input authenticating a user for a transaction, the computing device is configured to:
transmit, to the first controller, a first signal configured to cause the first controller to unlock a lock mechanism of the first storage area to enable access by the user to the first storage area; and
transmit, to the second controller, a second signal configured to cause the second controller to unlock a lock mechanism of the second storage area to enable access by the user to the second storage area.

12. The joined cabinet system of claim 11, wherein the first signal and the second signal are generated based on the input and the input is obtained from a computer terminal at which the transaction is initiated.

13. The joined cabinet system of claim 12, wherein the computer terminal is a vending interface device integrated on or within the primary merchandiser device.

14. The joined cabinet system of claim 12, wherein the computer terminal is a personal mobile device.

15. The joined cabinet system of claim 12, wherein the primary merchandiser device and the secondary merchandiser device are daisy chained via the computing device.

16. The joined cabinet system of claim 11, wherein the first signal and the second signal cause a simultaneous unlocking of the lock mechanism of the first storage area and the lock mechanism of the second storage area.

17. A joined cabinet system, comprising:
a primary merchandiser device including a computing device, a first controller, and a first storage area; and
a secondary merchandiser device including a second controller and a second storage area,
wherein the first controller, via a first signal transmitted from the computing device based on input authenticating a user for a transaction, unlocks a lock mechanism of the first storage area to enable access to the first storage area,
wherein the second controller, via a second signal transmitted from the computing device based on the input, unlocks a lock mechanism of the second storage area to enable access to the second storage area, and
wherein the primary merchandiser device and the secondary merchandiser device are daisy chained via the computing device.

18. The joined cabinet system of claim 17, comprising:
a computer terminal from which the input is obtained.

19. The joined cabinet system of claim 17, comprising:
one or more cameras activated via one or both of the first signal or the second signal, wherein the one or more cameras are configured to capture images or video used to identify products associated with the transaction.

20. The joined cabinet system of claim 17, wherein the lock mechanism of the first storage area and the lock mechanism of the second storage area are simultaneously unlocked.
